(19) United States
(12) Patent Application Publication
(10) Pub. No.: US 2018/0293531 A1
(43) Pub. Date: Oct. 11, 2018

(54) Work Entrustment Support System and Method Therefor

(71) Applicant: Hitachi, Ltd., Tokyo (JP)

(72) Inventors: Koji KAMODA, Tokyo (JP); Takafumi CHIDA, Tokyo (JP)

(21) Appl. No.: 15/934,434

(22) Filed: Mar. 23, 2018

(30) Foreign Application Priority Data
Apr. 10, 2017 (JP) 2017-077567

(51) Int. Cl. G06Q 10/06

(52) U.S. Cl. CPC G06Q 10/063112; G06Q 10/06313; G06Q 10/06393; G06Q 10/06398; G06Q 10/06316

(57) ABSTRACT

Even if there are a plurality of items regarding work, a resource of a work trustee can be evaluated, and thus work entrustment is supported. A work entrustment support system includes a storage unit in which resource information in which an item of which work can be performed by a work trustee is correlated with the work trustee is stored, a work sequence generation unit that generates work schedules on the basis of design information, a priority key setting unit that stores information regarding the priority of each of a plurality of items regarding work in the storage unit, a rank value computation unit that evaluates the resource information stored in the storage unit for each of the work schedules generated by the work sequence generation unit on the basis of the information regarding the priority stored by the priority key setting unit, and a display unit that displays a work trustee according to a rank based on evaluation in the rank value computation unit

### TECHNICAL FIELD

The present invention relates to a work entrustment support system and a method therefor.

### BACKGROUND ART

There is PTL 1 as the background art of the present technical field. PTL 1 discloses a business intermediation system which can give, to a purchaser, an opportunity to select traders of various kinds of trades to reach a final result.

### CITATION LIST

### Patent Literature

PTL 1: JP-A-2002-150034

### SUMMARY OF INVENTION

### Technical Problem

PTL 1 discloses a method in which trade link candidates which are arrangement of traders according to a supply chain which is the best in a standard designated by the purchaser are automatically sorted and are presented to the purchaser. However, in the presentation method to a purchaser in PTL 1, only one option of the delivery date, a price, and accuracy can be set when trade link candidates are sorted.

In the presentation method to a purchaser, for example, a trade link candidate according to a supply chain which is comprehensively determined as being favorable by taking into consideration a plurality of options cannot be sorted out or cannot be presented to a purchaser.

Therefore, an object of the present invention is to support work entrustment by enabling a resource of a work trustee to be evaluated even if there are a plurality of items regarding work.

### Solution to Problem

In order to solve the problem, according to the present invention, there is provided a work entrustment support system including a storage unit in which resource information in which an item of which work can be performed by a work trustee is correlated with the work trustee is stored; a work sequence generation unit that generates work schedules on the basis of design information; a priority key setting unit that stores information regarding the priority of each of a plurality of items regarding work in the storage unit; a rank value computation unit that evaluates the resource information stored in the storage unit for each of the work schedules generated by the work sequence generation unit on the basis of the information regarding the priority stored by the priority key setting unit; and a display unit that displays a work trustee according to a rank based on evaluation in the rank value computation unit.

### Advantageous Effects of Invention

According to the present invention, even if there are a plurality of items regarding work, a resource of a work trustee can be evaluated, and thus it is possible to support work entrustment.

### BRIEF DESCRIPTION OF DRAWINGS

FIG. 1 is a diagram illustrating an example of a work trustee selection system.

FIG. 2 is a flowchart illustrating a work trustee selection process.

FIG. 3 is a diagram illustrating an example of a BOM.

FIG. 4 is a diagram illustrating an example of a component.

FIG. 5 is a diagram illustrating an example of a BOP.

FIG. 6 is a diagram illustrating an example of candidate ranking priority key information.

FIG. 7 is a diagram illustrating an example of resource attribute information.

FIG. 8 is a diagram illustrating an example of processing specification information.

FIG. 9 is a diagram illustrating examples of procedures of generating work trustee candidate information.

FIG. 10 is a diagram illustrating an example of a setting screen for a candidate ranking priority key information.

FIG. 11 is a diagram illustrating an example of a display screen for a candidate ranking result.

FIG. 12 is a diagram illustrating an example of candidate ranking priority key information.

FIG. 13 is a diagram illustrating an example of adjacent part relationship data.

FIG. 14 is a diagram illustrating an example of entrustment scheduled establishment data.

FIG. 15 is a diagram illustrating an example of group information for usage materials.

FIG. 16 is a diagram illustrating an example of facility allocation information.

FIG. 17 is a diagram illustrating examples of system input and output.

### DESCRIPTION OF EMBODIMENTS

Hereinafter, Examples will be described with reference to the drawings.

### Example 1

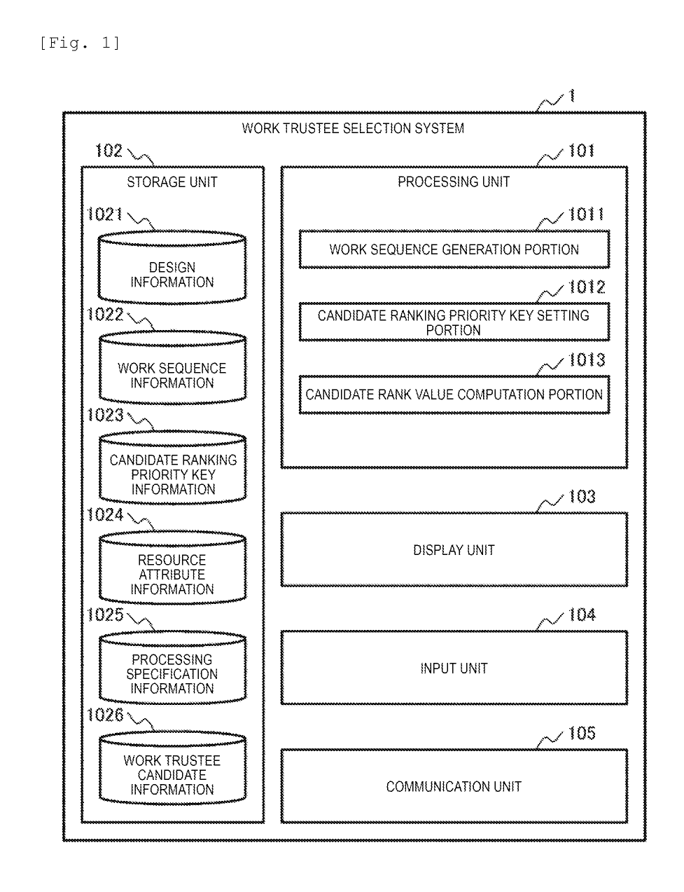

FIG. 1 is a diagram illustrating an example of a work trustee selection system 1 according to an embodiment of the present invention. As illustrated in FIG. 1, the work trustee selection system 1 includes a processing unit 101, a storage unit 102, a display unit 103, an input unit 104, and a communication unit 105. The processing unit 101 includes a work sequence generation portion 1011, a candidate ranking priority key setting portion 1012, and a candidate rank value computation portion 1013.

The work trustee selection system 1 may be, for example, a computer. The processing unit 101 may include a processor and a memory in which the program is stored. Programs for the work sequence generation portion 1011, the candidate ranking priority key setting portion 1012, and the candidate rank value computation portion 1013 may be stored in the memory of the processing unit 101, and the processor executing each program may function as each portion. A program (not illustrated) may be further stored in the memory of the processing unit 101, and may be executed by the processor.

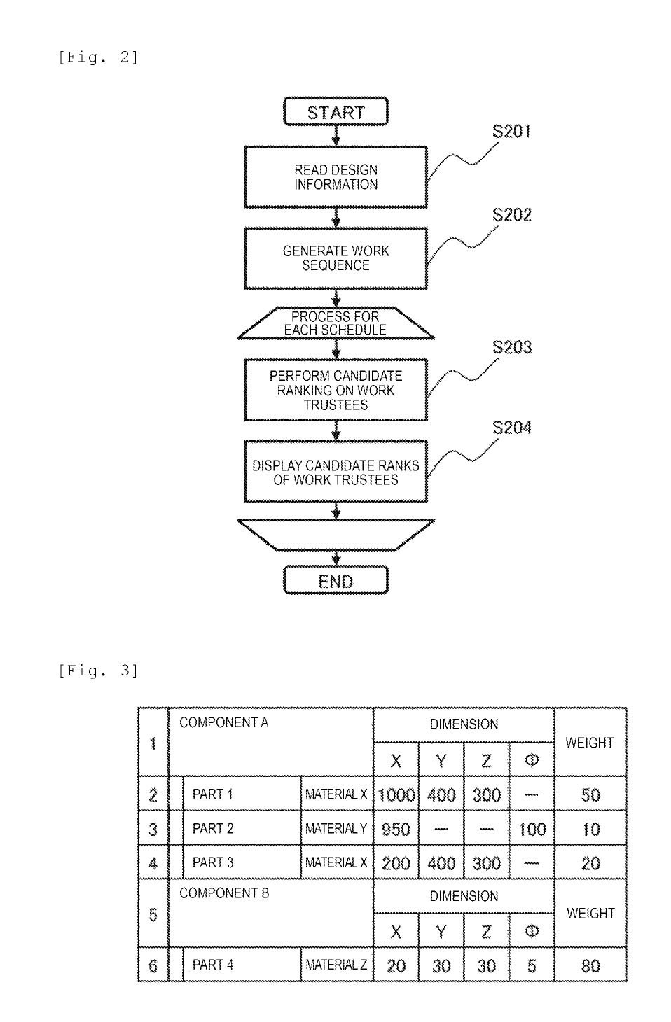

The storage unit 102 may be a memory, a hard disk drive (HDD), or a solid state drive (SSD), and information stored therein will be described later with reference to FIGS. 2 to 9. The same information or the same program may be stored in the memory of the processing unit 101 and the storage unit 102. The display unit 103 may be a display device, and the input unit 104 may be a keyboard, a mouse, or a touch panel, and receives a user's operation.

The communication unit 105 may be a network interface, and may be connected to a local network (not illustrated) or the Internet. The work trustee selection system 1 may not include the display unit 103 and the input unit 104, and may be controlled from a remote place via a network by using the communication unit 105 instead thereof. The work trustee selection system 1 may be formed of a plurality of computers.

Hereinafter, each constituent element of the work trustee selection system 1 will be described with reference to a flowchart of FIG. 2 illustrating an example of a work trustee selection process performed by the work trustee selection system 1. As illustrated in FIG. 2, first, in step S201, the processing unit 101 reads design information 1021 to the storage unit 102. For example, the design information 1021 may be created by using general 3D-computer aided design (CAD) software, and 3D-CAD data stored in a storage device of an external server or a cloud connected to a network is received by the communication unit 105, and is held as the design information 1021 of the storage unit 102.

Next, in step S202, the work sequence generation portion 1011 of the processing unit 101 generates work sequence information 1022 by using the design information 1021. For example, in the work sequence generation in step S202, bill of process (BOP) data which may be generated by using a general bill of materials (BOM) or product data management (PDM) system or software may be used as the work sequence information 1022. The BOM or PDM system or software may be executed by the processing unit 101, and work sequence information generated in an external system may be incorporated into the work sequence information 1022 of the storage unit 102 so as to be held.

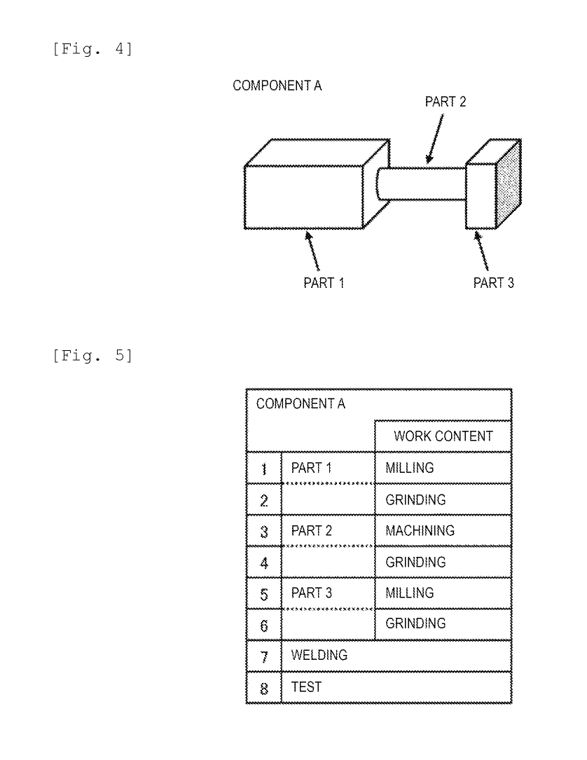

FIG. 3 illustrates an example of a BOM. The BOM in FIG. 3 is created for a component A illustrated in FIG. 4 as an example. The component A in FIG. 4 is formed of a part 1, a part 2, and a part 3, and the respective parts have a connection relationship as illustrated in FIG. 4. The BOM in FIG. 3 includes information indicating that the component A in FIG. 4 is formed of parts such as the part 1, the part 2, and the part 3.

The BOM in FIG. 3 includes information indicating that a usage material is a “material X”, a dimension X is “1000”, a dimension Y is “400”, a dimension Z is “300”, and a weight is “50” as attribute information of the part 1. The BOM also includes information indicating that the part 1 is formed in a shape with no value corresponding to ϕ, that is, the part 1 has no value of ϕ. This information is written as “-” in FIG. 3.

The BOM in FIG. 3 also includes information regarding a component B, and, although illustration as in FIG. 4 is omitted with regard to the component B, information of the BOM indicates that the component B is formed of a part 4. As illustrated in FIG. 3, the component A is formed of the part 1, the part 2, and the part 3, the component B is formed of the part 4, and the component A and the component B form high-order components. Thus, in the BOM, configuration information of components and parts is managed in a tree structure.

The design information 1021 may include the BOM in FIG. 3 and information indicating a connection relationship as illustrated in FIG. 4. Here, the component and the part are expressed in different terms in order to differentiate a high order and a low order from each other in the tree structure managed in the BOM, and the term “component” and the term “part” may be replaced with each other. Thus, in a case where a high-order component is formed by combining the component A with component B, if work entrustment of each of the component A and the component B is performed, the component A and the component B may be expressed as the part A and the part B.

FIG. 5 illustrates an example of a BOP. The BOP in FIG. 5 is a BOP for the component A illustrated in FIG. 4. In order to generate the BOP in FIG. 5 including assembling procedures (schedule) of the component A in FIG. 4, a system which is generally sold and creates an assembling flow (schedule) on the basis of a shape or an attribute of 3D-CAD may be used.

The BOP in FIG. 5 includes information indicating that the part 1 is milled as a first schedule, the part 1 is ground as a second schedule, and the part 2 is brought into machining as a third schedule. The BOP may include information other than the information illustrated in FIG. 5, and the work sequence information 1022 may include the BOP and other information.

Referring to FIG. 2 again, step S203 and step S204 are repeatedly performed for each schedule of the BOP in FIG. 5. In the example of the BOP in FIG. 5, there are eight schedules, and thus the steps are repeatedly performed eight times, and, first, the part 1 and milling in the first schedule are targets of the steps.

In step S203, the candidate ranking priority key setting portion 1012 of the processing unit 101 generates candidate ranking priority key information 1023, and the candidate rank value computation portion 1013 of the processing unit 101 generates work trustee candidate information 1026 by using the work sequence information 1022 (the BOP in FIG. 5), the candidate ranking priority key information 1023, resource attribute information 1024, and processing specification information 1025.

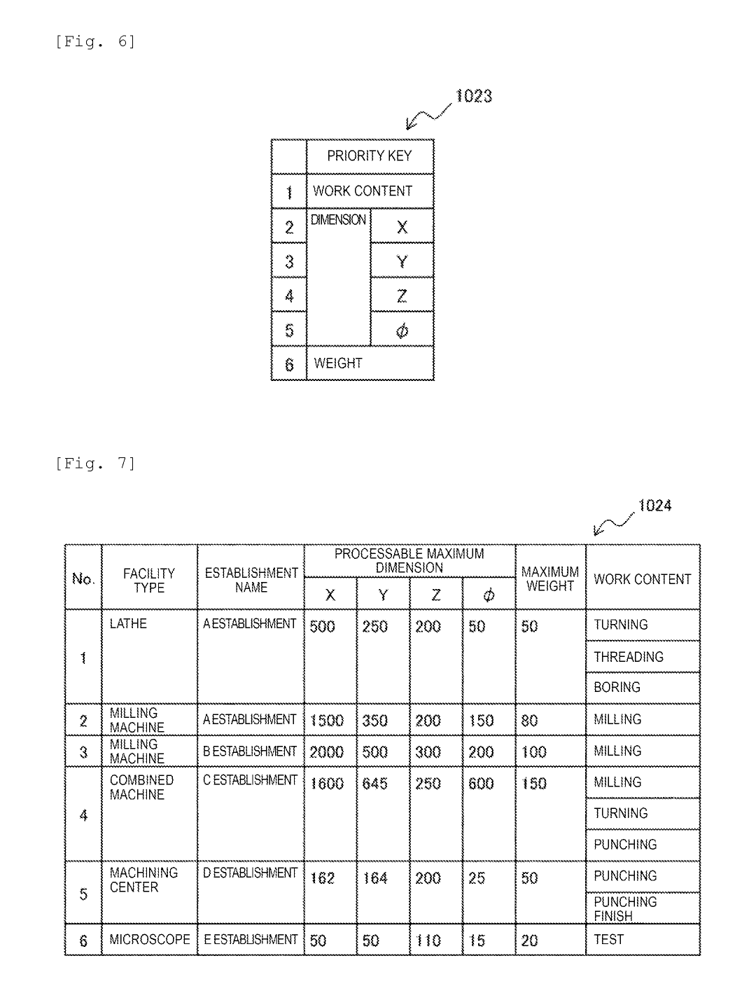

Details thereof will be described with reference to FIGS. 6 to 9. The candidate ranking priority key information 1023 which is set in order to prioritize selection elements when a work trustee candidate to be set is selected is used by the candidate ranking priority key setting portion 1012 in the work trustee candidate ranking in step S203.

FIG. 10 illustrates an example of a setting screen for the candidate ranking priority key information 1023. The setting screen is displayed on the display unit 103, and an operation on the setting screen is received via the mouse of the input unit 104. The setting screen is an example of a screen on which a priority key target item is selected through a user's operation from a priority key list on the setting screen, and a position of the order of a priority key desired to be set is selected, and is set in a priority key setting order by pressing a registration button. Here, the priority may be displayed in each item of the priority key setting order in a number.

Even if an item is set in the priority key setting order by pressing the registration button, an item of the priority key setting order is selected, and the selected item is deleted from the priority key setting order by pressing a deletion button. In a case where an item is set in the priority key setting order, and an OK button is pressed, the candidate ranking priority key information 1023 is generated on the basis of the items of the priority key setting order.

If a back button is pressed, step S203 is finished, then step S204 may be skipped, and a loop in the next schedule may be executed, and the work trustee selection process illustrated in FIG. 2 may be finished. The priority key list may be set in advance, and may be set by extracting the items of the BOM.

FIG. 6 illustrates an example of the candidate ranking priority key information 1023. The example of the candidate ranking priority key information 1023 in FIG. 6 illustrates a state in which the priority is set in an order of “work content”, “X”, “Y”, “Z”, “ϕ”, and “weight” from higher priority to lower priority.

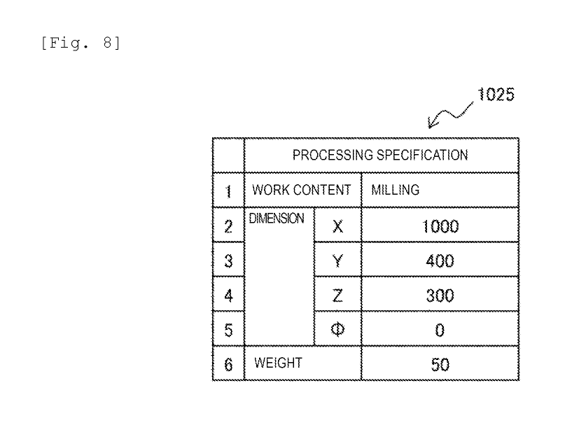

FIG. 7 illustrates an example of the resource attribute information 1024. In the example of the resource attribute information 1024 in FIG. 7, a resource number (No.), a facility type, an establishment name, processable maximum dimensions (X, Y, Z, and (I)), the maximum weight, and the work content are registered. The processable maximum dimensions are the maximum dimensions of a processing target object obtained as a result of processing, and indicate that an object having dimensions larger than the processable maximum dimensions cannot be processed (by using information registered in the resource attribute information 1024).

The maximum weight is the maximum weight of a processing target object obtained as a result of processing, and indicates that an object heavier than the maximum weight cannot be processed (by using information registered in the resource attribute information 1024). The establishment name is the name of a work trustee establishment, and the facility type is the type of facility which can be used in each establishment.

The work content is work which can be performed by a facility identified by the facility type, and is information corresponding to the work content of the BOP in FIG. 5. If any one of the facility type, the establishment name, the processable maximum dimension, and the maximum weight differs, the resource number is a number allocated whenever differing occurs. In the example illustrated in FIG. 7, the same resource number is allocated even if pieces of the work content are different from each other, but different resource numbers may be allocated whenever pieces of the work content are different from each other.

Next, FIG. 8 illustrates an example of the processing specification information 1025. The processing specification specifically indicates the content of work entrustment, and the processing specification information 1025 in FIG. 8 relates to the part 1 of the component A in FIG. 4 as an example. In a case of the part 1, the entrusted work content is “milling” from the BOP in FIG. 5, and processing dimensions are “1000” in an X axis direction, “400” in a Y axis direction, and “300” in a Z axis direction from the BOM (design information 1021) in FIG. 3.

Here, the part 1 does not have a shape corresponding to ϕ, and thus ϕ is written as “0” in the processing specification information 1025. FIG. 8 illustrates an example of “milling” as the first schedule of the BOP in FIG. 5, but processing specifications for other schedules including “grinding” as the second schedule are included in the processing specification information 1025 as other tables.

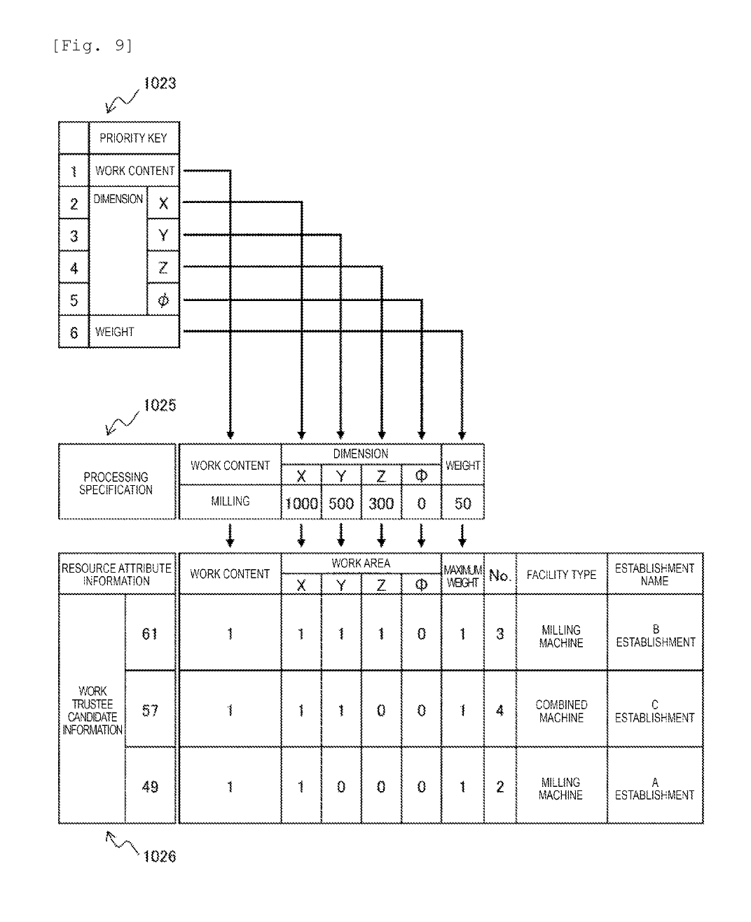

Hereinafter, with reference to FIG. 9, a description will be made of procedures of generating work trustee candidate information 1026 on the basis of the candidate ranking priority key information 1023, the resource attribute information 1024, and the processing specification information 1025 described with reference to FIGS. 6 to 8. First, in the example of the candidate ranking priority key information 1023 in FIG. 6, the priority of selection elements of when a work trustee candidate is selected is set in an order of “work content”, “X”, “Y”, “Z”, “ϕ”, and “weight” from higher priority.

The processing specification information 1025 in FIG. 8 is collated with the resource attribute information 1024 in FIG. 7 according to the order in the candidate ranking priority key information 1023, and, binary numbers such as 0 and 1 are assigned, for example, “1” is assigned in a case where a condition (that matching occurs or processing can be performed) is satisfied for each item, and “0” is assigned in a case where the condition is not satisfied. In the example illustrated in FIG. 9, in the resource attribute information 1024 in FIG. 7, for example, the resources with the resource numbers (No.) of “2”, “3”, and “4” satisfy some conditions among the work content, X, Y, Z, and the weight.

If “1” and “0” are arranged according to the order in the candidate ranking priority key information 1023 (if “1” and “0” are arranged such that items with higher priority are placed in high-order digits), the resource with the resource number (No.) of 2 has a binary number of “110001”, and the binary number is converted into a decimal number of “49”. Through similar conversion, the resource with the resource number (No.) of “3” has “61” at “111101”, and the resource with the resource number (No.) of “4” has “57” at “111001”.

When rearranged in the order of the decimal number being greater, a candidate rank of the resource with the resource number (No.) of “3” including that the facility type is a “milling machine” and the establishment name is “B establishment” is highest. In the above-described way, the work trustee candidate information 1026 is generated. The example illustrated in FIG. 9 shows the top three resources in the candidate rank, but the work trustee candidate information 1026 may include information regarding more resources.

Regarding candidate ranking, a description has been made of an example in which candidates are ranked by generating a binary number such as “0” and “1” on the basis of a condition of a value (information) of each item of the resource attribute information 1024 is satisfied, but procedures of candidate ranking are not limited thereto, and a score may be set in a case where a condition is satisfied for each item of the resource attribute information 1024 and the processing specification information 1025, and candidates may be ranked according to a total score.

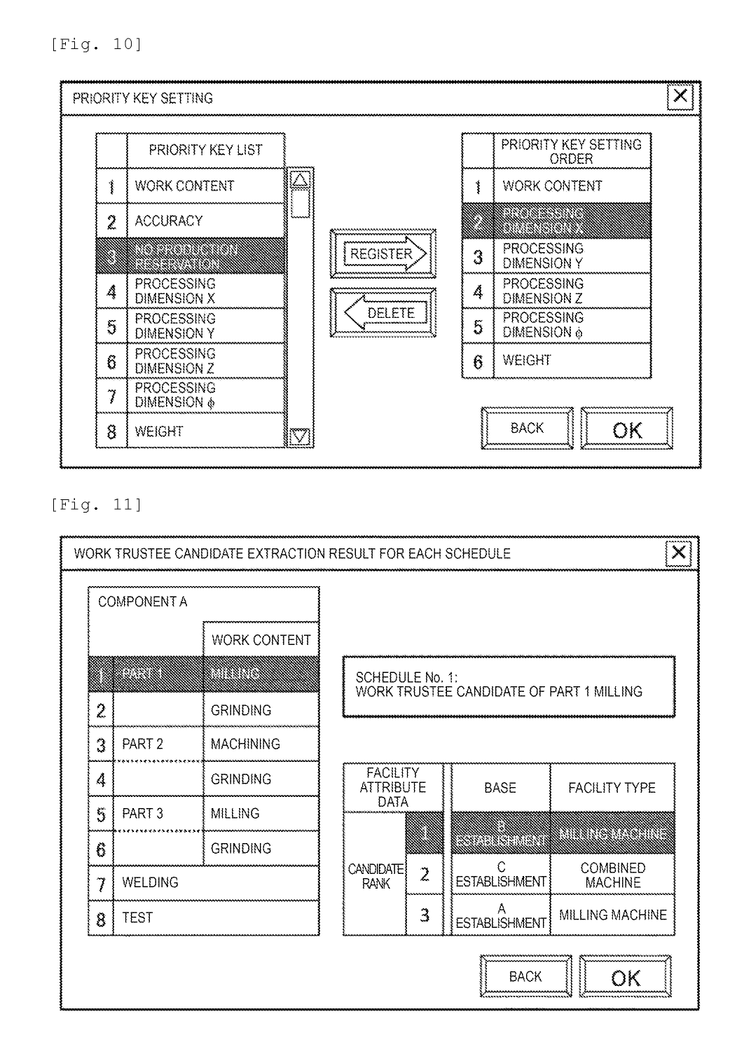

Referring to FIG. 2 again, in step S204, the processing unit 101 displays a candidate ranking result of a work trustee on the display unit 103 for each schedule. FIG. 11 illustrates an example of a display screen for candidate ranking. FIG. 11 illustrates an example of a screen on which the work content of milling for the part 1 is selected, and work trustee candidates for the work content are displayed in a state of being sorted according to candidate ranking.

For example, the BOP included in the work sequence information 1022 is displayed, display of a schedule selected in the process loop for each schedule of step S203 and step S204 is inversed in the display of the BOP, and the inversed content is displayed as “schedule No. 1”. Establishment names and facility types are displayed in a descending order of a decimal number of the work trustee candidate information 1026. If an OK button is pressed, the flow may return to step S203 which is a leading step of the loop in order to proceed to the next schedule, and, if a back button is pressed, the loop may be finished.

Since step S204 is executed in the loop, the display screen for a candidate ranking result in FIG. 11 is displayed for each schedule, but information regarding a plurality of schedules may be stored in the work trustee candidate information 1026 for each schedule so as to be able to be identified, and step S204 may be executed after the loop. Also in this case, the display screen for candidate ranking in FIG. 11 may be used, and, if a schedule is selected from the display of the BOP by using the mouse or the like of the input unit 104, a candidate rank regarding the selected schedule may be displayed.

In a case where the resource including that a “candidate rank” of “facility attribute data” illustrated in FIG. 11 is “1”, a “base” is “B establishment”, and the “facility type” is a “milling machine” is selected by using the mouse or the like of the input unit 104, the display may be inversed as illustrated in FIG. 11, and, if the OK button is pressed, information in which the selected resource is a work trustee (entrustment scheduled establishment) may be generated.

A production reservation situation of a facility may be set in each of the candidate ranking priority key information 1023 and the resource attribute information 1024, candidate ranking is performed according to such a set item, and thus it is possible to improve an operation rate since work is preferentially entrusted to a facility of which there is no production reservation.

As described above, even if there are a plurality of items regarding work, that is, a plurality of items including pieces of work content such as milling, and dimensions, it is possible to evaluate resources of work trustees, that is, to rank candidates by using the plurality of items according to the priority assigned to the plurality of items.

The items regarding work may also indicate a feature of a processing target object, such as a dimension of a part, and thus evaluation can be performed at technical items rather than clerical items. A candidate ranking result is displayed to be understood by a user, and thus enables the user to easily select a work trustee, so as to support work entrustment.

Even if there is information indicating that a resource of a work trustee is not processable, a low rank can be displayed, and, since even a plurality of resources having information indicating that the resources are not processable are ranked, it is possible to support negotiation with a work trustee such that a resource becomes processable.

### Example 2

In Example 1, there is a probability that a candidate rank of the same work trustee for a plurality of parts adjacent to each other may be high, but, in Example 2, a description will be made of an example in which a candidate rank of the same work trustee for a plurality of parts adjacent to each other is not high. In the work trustee selection system 1 described with reference to FIG. 1 and the like, description of the same configuration as that in Example 1 will be omitted, and a differing configuration between Example 1 and Example 2 will be described.

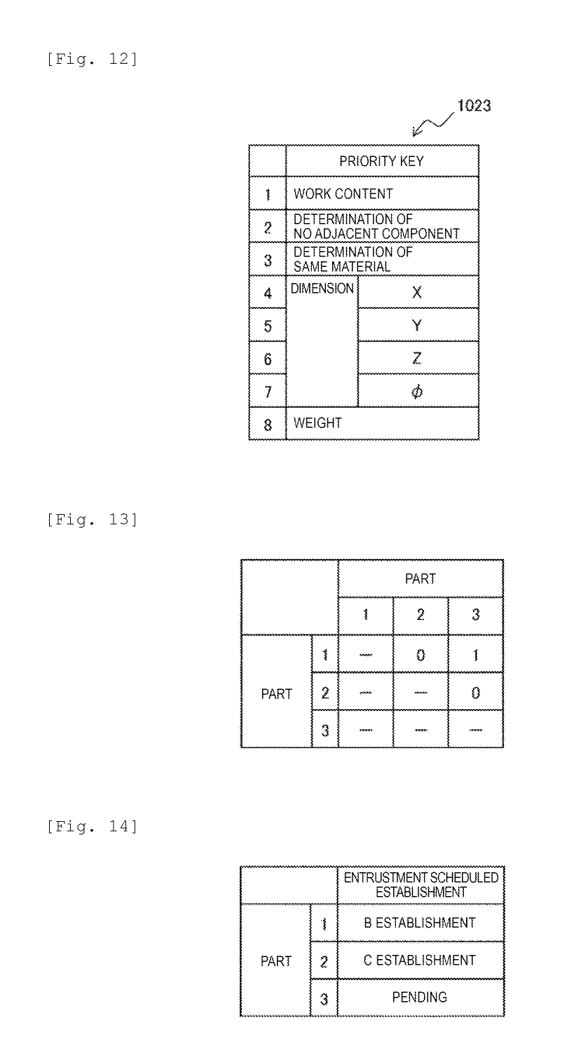

FIG. 12 is a diagram illustrating an example of candidate ranking priority key information 1023 in Example 2. In Example 2, the candidate ranking priority key information 1023 as illustrated in FIG. 12 is used in step S203 related to work trustee candidate ranking in FIG. 2.

In the candidate ranking priority key information 1023 in FIG. 12, “determination of no adjacent component” and “determination of the same material” are newly added thereto as the next priority of the “work content”. Each of the “determination of no adjacent component” and the “determination of the same material” is information indicating being reflected in calculation of a candidate rank, and any flag indicating the information may be used.

First, adjacent component relationship data illustrated in FIG. 13 is calculated in advance on the basis of position information and size information of each part in 3D-CAD data (design information 1021). If the 3D-CAD data includes adjacent component relationship information, the adjacent component relationship data may be acquired in advance. The example illustrated in FIG. 13 shows that, in a case where two parts are adjacent to each other, “0” is set, in a case where the parts are not adjacent to each other, “1” is set, the part 1 is not adjacent to the part 3, and the part 2 is adjacent thereto.

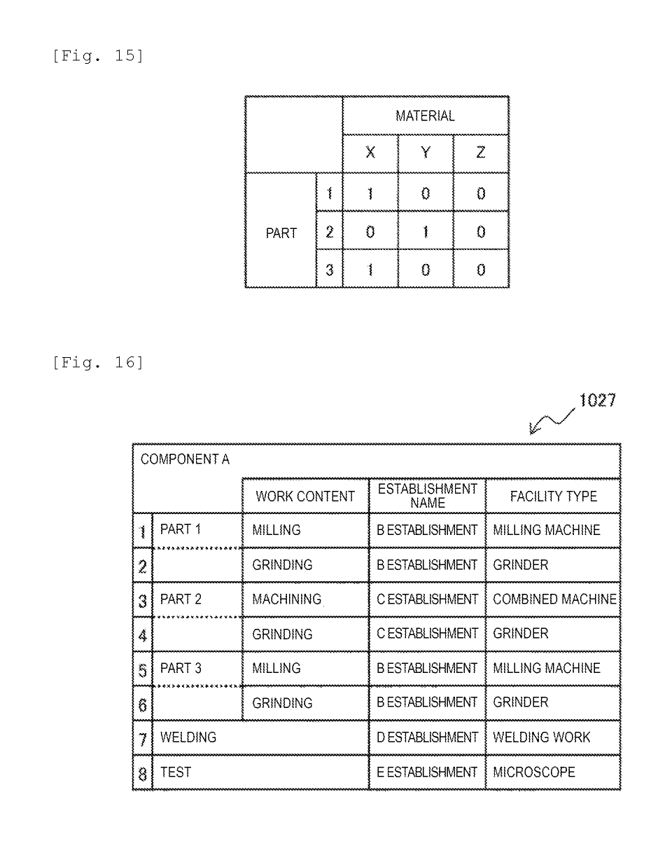

In the loop including step S203 and step S204 in FIG. 2, an entrustment scheduled establishment is set whenever step S203 and step S204 are executed, and thus entrustment scheduled establishment data illustrated in FIG. 14 is generated.

An entrustment scheduled establishment to be set may be an establishment of which a candidate rank is calculated as the first rank, and may be an establishment of a resource selected by using the mouse or the like of the input unit 104 from among resources, illustrated in FIG. 11, in which candidates are ranked. In an example illustrated in FIG. 14, step S203 and step S204 are already executed as a process for each schedule for the part 1 and the part 2, entrustment scheduled establishments for the part 1 and the part 2 are set, and an entrustment scheduled establishment for the part 3 is not set (pending).

As a process for each schedule for the part 3, in step S203, in a case where “determination of no adjacent component” is included in the candidate ranking priority key information 1023, the candidate rank value computation portion 1013 acquires information indicating that the part 3 is not adjacent to the part 1 and is adjacent to the part 2 from the adjacent component relationship data in FIG. 13, and generates the work trustee candidate information 1026 in which a binary number of the resource including the “B establishment” for the part 1 is “1”, and a binary number of the resource including the “C establishment” for the part 2 is “0” on the basis of the entrustment scheduled establishment data in FIG. 14. Consequently, it is possible to increase a decimal number of the resource including the B establishment which is an entrustment scheduled establishment for the part 1 not adjacent.

FIG. 15 is a diagram illustrating an example of material relationship data indicating a group of usage materials of each part. The material relationship data in FIG. 15 is generated in advance by acquiring information such the “material X” from the BOM (design information 1021) in FIG. 3. The example illustrated in FIG. 15 illustrates that, in a case where each part includes a corresponding material, “1” is set, in a case where each part does not include the material, “0” is set, and the part 1 and the part 3 include the same material, for example, the material X.

As a process for each schedule for the part 3, in step S203, in a case where “determination of the same material” is included in the candidate ranking priority key information 1023, the candidate rank value computation portion 1013 acquires information indicating that the part 3 and the part 1 include the same material, and the part 2 does not include the same material, from the material relationship data in FIG. 15, and generates the work trustee candidate information 1026 in which a binary number of the resource including the “B establishment” for the part 1 is “1”, and a binary number of the resource including the “C establishment” for the part 2 is “0” on the basis of the entrustment scheduled establishment data in FIG. 14. Consequently, it is possible to increase a decimal number of the resource including the B establishment which is an entrustment scheduled establishment for the part 1 including the same material.

The data illustrated in FIGS. 13 to 15 may be stored in the storage unit 102.

As described above, adjacent parts can increase a candidate rank of each of different work trustees. Consequently, information regarding a component obtained by assembling a plurality of parts is distributed, and thus it is hard to estimate information regarding the component. In a case where the component is assembled into a product, security of product information can be improved. Particularly, this is effective to security of product information in a case where processing work of a prototype of a product is entrusted. Above all, it is possible to heighten a candidate rank of a work trustee for a component including the same material.

### Example 3

In Examples 1 and 2, a description has been made of an example in which a candidate rank is displayed, or a work trustee establishment is selected on the basis of the displayed candidate ranks, but, in Example 3, a description will be made of an example in which a work instruction is given to a selected work trustee establishment, and work such as processing is performed in the work trustee establishment. In the work trustee selection system 1 described with reference to FIG. 1 and the like, description of the same configuration as that in Examples 1 and 2 will be omitted, and a differing configuration between Examples 1 and 2 and Example 3 will be described.

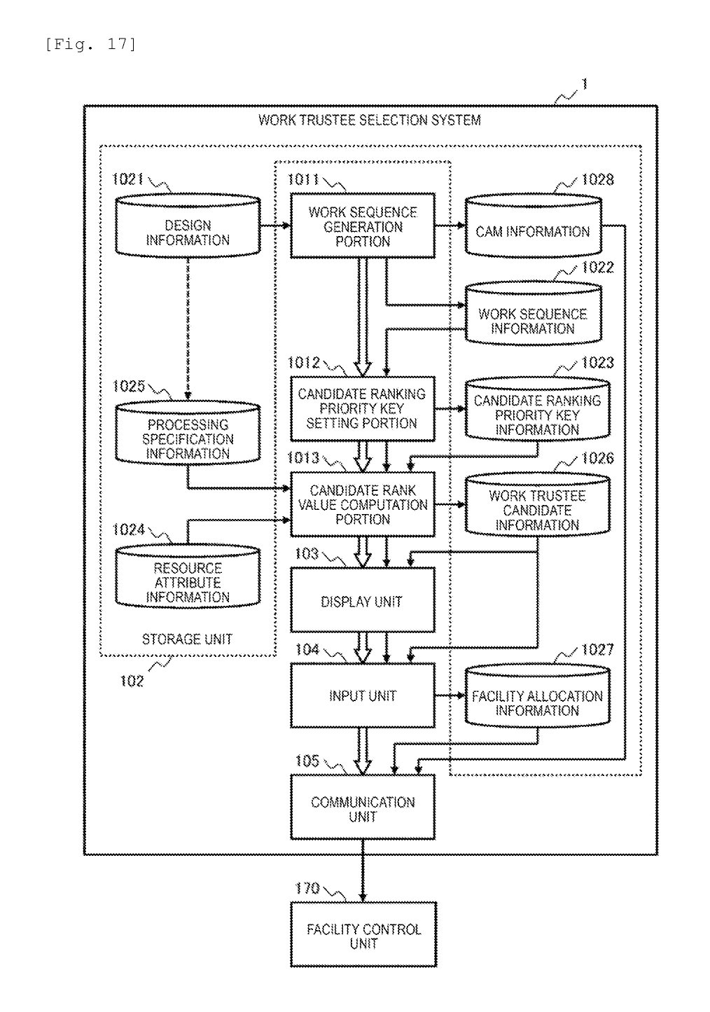

As described with reference to FIGS. 9, 11 and 14, in a case where a resource is selected or a resource having the first candidate rank is selected on the candidate ranking display screen in FIG. 11 based on the work trustee candidate information 1026 in FIG. 9 by using the input unit 104, an establishment name and a facility type of the selected resource can be determined. Consequently, as illustrated in FIG. 16, facility allocation information 1027 to which the facility name and the facility type are added to each schedule of the BOP is generated. The facility allocation information 1027 may be stored in the storage unit 102.

FIG. 17 is a diagram illustrating an example of system input and output of the work trustee selection system 1 in Example 3. For example, a thick arrow between the work sequence generation portion 1011 and the candidate ranking priority key setting portion 1012 indicates a flow of a process, and other thin arrows indicate a flow of data. Since the work sequence information 1022 (BOP) is used in each portion, for example, a flow of data between the candidate ranking priority key setting portion 1012 and the candidate rank value computation portion 1013 is indicated by the thin arrow.

The work sequence generation portion 1011 performing a process in the processing unit 101 of the work trustee selection system 1 generates CAM information 1028 by using a computer aided manufacturing (CAM) system which generates path information (tool path) of a tool for cutting on the basis of 3D-CAD information. The CAM information 1028 may also be stored in the storage unit 102.

Data of the CAM information 1028 directly transmitted to each facility of a work trustee establishment via the communication unit 105 on the basis of the CAM information 1028 and the facility allocation information 1027 in FIG. 16. In other words, the data of the CAM information 1028 is directly input to a facility control unit 170 of the work trustee establishment, and thus a direct control instruction is given to a facility.

A tool to be used, a processing distance, and a processing time may be obtained by using the tool path information of the CAM information 1028, and undertaking cost for work entrustment may be added to the resource attribute information 1024 with a price per work time as a reference. The price per work time is adjusted according to a depreciation situation of a facility, and thus easily contributes to shortening an investment recovery period.

As described above, it is possible to perform automation of selection of a work trustee to control of a facility for processing. Consequently, it is possible to considerably reduce the number of schedules for a user's ordering.

In the above Examples 1 to 3, a processing facility has been described as an example, but the present invention may be applied not only to the processing facility but also to general production resources of other industrial fields, such as coating devices or test devices, and the work trustee selection system may also be used as a selection system for a work trustee including a worker by handling skill information such as qualification information of the worker as attribute information of a production resource. Examples 1 to 3 have been described separately, but some of the configurations described in each Example may be applied to configurations of other Examples.

### REFERENCE SIGNS LIST

1: WORK TRUSTEE SELECTION SYSTEM
1012: CANDIDATE RANKING PRIORITY KEY SETTING PORTION
1013: CANDIDATE RANK VALUE COMPUTATION PORTION
1023: CANDIDATE RANKING PRIORITY KEY INFORMATION
1024: RESOURCE ATTRIBUTE INFORMATION
1026: WORK TRUSTEE CANDIDATE INFORMATION

1. A work entrustment support system comprising:
a storage unit in which resource information in which an item of which work can be performed by a work trustee is correlated with the work trustee is stored;
a work sequence generation unit that generates work schedules on the basis of design information;
a priority key setting unit that stores information regarding the priority of each of a plurality of items regarding work in the storage unit;
a rank value computation unit that evaluates the resource information stored in the storage unit for each of the work schedules generated by the work sequence generation unit on the basis of the information regarding the priority stored by the priority key setting unit; and
a display unit that displays a work trustee according to a rank based on evaluation in the rank value computation unit.

2. The work entrustment support system according to claim 1,
wherein the work includes processing, and
wherein the items regarding the work include dimensions of a processing target object.

3. The work entrustment support system according to claim 2,
wherein the item of which work can be performed by the work trustee in the resource information stored in the storage unit includes the maximum dimension of a processable target object.

4. The work entrustment support system according to claim 3,
wherein the rank value computation unit gives higher evaluation to a case where the maximum dimension of the processable target object included in the item of which work can be performed by the work trustee in the resource information stored in the storage unit is larger than a dimension of a processing target object than a case where the maximum dimension is not larger than the dimension of the processing target object.

5. The work entrustment support system according to claim 4,
wherein the items regarding the work further include the work content for a processing target object,
wherein the item of which work can be performed by the work trustee in the resource information stored in the storage unit further includes the work content, and
wherein the rank value computation unit gives higher evaluation to a case where the work content included in the item of which work can be performed by the work trustee in the resource information stored in the storage unit matches the work content for a processing target object than a case where the work content does not match the work content for the processing target object.

6. The work entrustment support system according to claim 5,
wherein the priority key setting unit stores information indicating that the priority of an item of the work content is higher than the priority of an item of a dimension of a processing target object in the storage unit, and
wherein the rank value computation unit gives higher evaluation to a case where the work content included in the item of which work can be performed by the work trustee in the resource information stored in the storage unit matches the work content for a processing target object than a case where the maximum dimension of the processable target object included in the item of which work can be performed by the work trustee in the resource information stored in the storage unit is larger than a dimension of the processing target object.

7. The work entrustment support system according to claim 6,
wherein a plurality of work trustees are stored in the storage unit, and
wherein the display unit displays the plurality of work trustees according to ranks based on evaluation in the rank value computation unit.

8. The work entrustment support system according to claim 1,
wherein the resource information stored in the storage unit includes information regarding work reservation in a work trustee,
wherein the priority key setting unit stores information regarding the priority for evaluating the work reservation in the work trustee in the storage unit, and
wherein the rank value computation unit further performs evaluation on the basis of the work reservation in the work trustee in a case where the information regarding the priority for evaluating the work reservation in the work trustee is stored in the storage unit.

9. The work entrustment support system according to claim 1,
wherein the work includes assembling of a plurality of parts,
wherein the priority key setting unit stores information regarding the priority for evaluating an adjacency relationship among the plurality of parts in the assembling in the storage unit, and
wherein the rank value computation unit further performs evaluation on the basis of the adjacency relationship among the plurality of parts in the assembling in a case where the information regarding the priority for evaluating the adjacency relationship among the plurality of parts in the assembling is stored in the storage unit.

10. The work entrustment support system according to claim 9,
wherein a plurality of work trustees are stored in the storage unit, and
wherein, in a case where the information regarding the priority for evaluating the adjacency relationship among the plurality of parts in the assembling is stored in the storage unit, the rank value computation unit acquires information regarding the adjacency relationship among the plurality of parts in the assembling, and give higher evaluation to a second work trustee to which parts not adjacent to each other are entrusted among the plurality of work trustees than a first work trustee to which adjacent parts are entrusted among the plurality of work trustees.

11. The work entrustment support system according to claim 1, further comprising:
a communication unit that performs communication with a control unit of a facility,
wherein a plurality of work trustees are stored in the storage unit,
wherein the work includes processing,
wherein the work sequence generation unit generates CAM information on the basis of design information,
wherein the rank value computation unit selects a work trustee corresponding to resource information given the highest evaluation from among the plurality of work trustees, and
wherein the communication unit transmits the CAM information generated by the work sequence generation unit to the work trustee selected by the rank value computation unit, and controls processing in the facility.

12. A work entrustment support system comprising:
a display unit that displays a plurality of candidates of items regarding work, displays a button for registration, and displays a plurality of registered items regarding the work in correlation with priorities thereof;
an input unit that receives an operation of selecting one of the plurality of displayed candidates of the items regarding the work, receives an operation of selecting the priority of a registered item of the work, and receives an operation of pressing the button for registration; and
a rank value computation unit that evaluates an item of which work can be performed by a work trustee on the basis of the priorities of the plurality of registered items regarding the work displayed on the display unit.

13. A work entrustment support method using a computer including a storage unit in which a program is stored, and resource information in which an item of which work can be performed by a work trustee is correlated with the work trustee is stored, a processing unit which executes the program stored in the storage unit, and a display unit, the method comprising:
causing the processing unit to execute the program and thus to perform control of
generating work schedules on the basis of design information;
storing information regarding the priority of each of a plurality of items regarding work in the storage unit;
evaluating the resource information stored in the storage unit for each of the generated work schedules on the basis of the information regarding the priority stored in the storage unit; and
displaying a work trustee according to an evaluated rank on the display unit.

14. The work entrustment support method according to claim 13,
wherein the work includes processing,
wherein the items regarding the work include dimensions of a processing target object,
wherein the item of which work can be performed by the work trustee in the resource information stored in the storage unit includes the maximum dimension of a processable target object, and
wherein the processing unit executes the program so as to give higher evaluation to a case where the maximum dimension of the processable target object included in the item of which work can be performed by the work trustee in the resource information stored in the storage unit is larger than a dimension of a processing target object than a case where the maximum dimension is not larger than the dimension of the processing target object.

15. The work entrustment support method according to claim 14,
wherein the items regarding the work include the work content for a processing target object,
wherein the item of which work can be performed by the work trustee in the resource information stored in the storage unit further includes the work content, and
wherein the processing unit executes the program so as to store information indicating that the priority of an item of the work content is higher than the priority of an item of a dimension of a processing target object in the storage unit, and to give higher evaluation to a case where the work content included in the item of which work can be performed by the work trustee in the resource information stored in the storage unit matches the work content for a processing target object than a case where the maximum dimension of the processable target object included in the item of which work can be performed by the work trustee in the resource information stored in the storage unit is larger than a dimension of the processing target object.
